(19) United States
(12) Patent Application Publication
(10) Pub. No.: US 2005/0221037 A1
(43) Pub. Date: Oct. 6, 2005

(54) Method of making heat transfer apparatus, apparatus thus manufactured, and method of using same

(76) Inventor: Albert A. Panyard, New Baltimore, MI (US)

Correspondence Address: CARRIER BLACKMAN AND ASSOCIATES, 24101 NOVI ROAD, SUITE 100, NOVI, MI, 48375, US

(21) Appl. No.: 10/675,474

(22) Filed: Sep. 30, 2003

Related U.S. Application Data
(60) Provisional application No. 60/414,973, filed on Sep. 30, 2002.

(51) Int. Cl. B32B 1/08

(52) U.S. Cl. 428/36.9; 264/319; 264/152

(57) ABSTRACT

A method for manufacturing a heat transfer device, includes the steps of forming tubing of a curable material, thereafter while the tubing is in a substantially uncured state, arranging the tubing into a desired shape such that surfaces of adjacent sections of the tubing are in contact with each other, and curing the shaped tubing while in said desired shape such that contacting surfaces said adjacent sections of said tubing are bonded together. A mold may be used for arranging the tubing sections into a desired shape. The curable material may be an elastomeric material which is flexible after curing, such a crosslinking silicone material.

### BACKGROUND OF THE INVENTION

1. Field of the Invention

The present invention relates to a flexible heat transfer apparatus used to heat and cool a workpiece or other object, and to methods of making and using same. More particularly, the present invention relates to a method of efficiently and inexpensively manufacturing such a heat transfer apparatus from flexible tubing.

2. Description of the Background Art

A number of different methods are known for making apparatus from plastic tubing. Examples of some of the known methods and products include U.S. Pat. No. 3,964,959 to Adams, U.S. Pat. No. 3,974,016 to Bondybey, U.S. Pat. No. 5,466,322 to Munsch, U.S. Pat. No. 5,958,167 to Van Driel et al., and U.S. Pat. No. 6,001,291 to Cesaroni.

For example, Bondybey, U.S. Pat. No. 3,974,016 discloses a method of using a laser beam to bond cylindrical strands, having a thermoplastic coating, together. The laser beam used has a wavelength of laser radiation that corresponds to an absorption frequency of the thermoplastic material.

As another example, Munsch, U.S. Pat. No. 5,466,322 discloses a method of creating a coil or other shape from an elongate plastic tube. After the tube is arranged in the appropriate manner, the tubes are plasticized, through RF heating, and adjacent sections are bonded together thereby.

A number of flexible heat transfer apparatus are known for heating or cooling a workpiece or other object. Examples of known heat transfer apparatus are the PolarCare Cub from JointHealing.com, the Shoulder Ice Pack System from Pain Relievers™, U.S. Pat. No. 6,074,415 to Der Ovanesian, and applicant's own U.S. Pat. Nos. 5,634,940 and 5,755,755.

The full disclosures of applicant's prior U.S. Pat. Nos. 5,634,940 and 5,755,755 are hereby incorporated by reference within this text.

Although the known apparatus and methods are useful for their intended purposes, a need still exists in the art for an improved method of manufacturing a flexible heat transfer apparatus and for a simple and relatively inexpensive heat transfer apparatus formed thereby.

### SUMMARY OF THE INVENTION

It is an object of the present invention to fulfill the discussed need in the art.

According to one aspect of the invention, a flexible heat transfer apparatus for contacting a workpiece, and for transferring heat relative to the workpiece, includes a heat transfer member formed from elongated flexible plastic tubing which has been prearranged into a given shape, corresponding to a workpiece to be contacted thereby, while in an uncured state. The heat transfer member includes numerous segments of the tubing in contact with one another.

After having been formed into the shape of the heat transfer member, the arranged tubing is subsequently cured with the adjacent segments remaining in contact, so that the adjacent engaging segments become fixedly bonded together. In one example of the present invention, the flexible plastic tubing comprises a crosslinkable elastomeric material.

For a therapeutic medical application thereof, the tubing may be shaped such that it is adapted to cover or to contact a specific body part.

In using the apparatus hereof, a flowable heat transfer medium is passed through the tubing while it is in contact with a workpiece, in order to heat up or cool down the workpiece. The tubing may be connected to the source of the flowable heat transfer medium through connector located at the ends of the tubing. A heat transfer apparatus according to the invention is advantageous because the simplified manufacturing process will result in a lower cost, and the apparatus includes fewer parts than the previously known apparatus.

The present invention also provides a method of manufacturing a shaped heat transfer apparatus for use with a flowable heat transfer medium. The method involves a step of applying a first selected length of uncured flexible plastic tubing against a mold to cover a portion thereof. The tubing is then coiled to apply a second selected length thereof against the mold, which may be in contact with the first length of tubing. The amount of the tubing in contact is based on the desired result (e.g., all of the tubing may be in contact, only small portions of the tubing may be in contact, or none of the tubing may be in contact). Coiling of the uncured tubing is repeated until the tubing covers the amount of the mold required to form the given shape, to form an uncured heat transfer member. Then, the heat transfer member is cured with the segments remaining in contact, such that the adjacent segments are bonded together.

Accordingly, it is an object of the invention to provide a simple, efficient method for economically producing a heat transfer apparatus. It is another object of the invention to provide a heat transfer apparatus which is adaptable for use in therapeutic medical treatment or in an industrial heat transfer application. It is a further object of the invention to provide a method of transferring heat to or from a workpiece using the apparatus hereof.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a schematic front elevational view including a portion of a patient's torso with a heat transfer apparatus associated therewith, according to a first embodiment of the invention applied thereto;

FIG. 2 is a detail view of the heat transfer apparatus of FIG. 1;

FIG. 3 is a perspective view of the heat transfer apparatus of FIGS. 1-2 disposed on a patient's shoulder;

FIG. 4 is a front plan view of a heat transfer apparatus according to a second embodiment of the invention;

FIG. 5 is a front plan view of a modified version of the heat transfer apparatus of FIG. 4, including tubes having different diameters;

FIG. 6 is a detail view of another modified version of the heat transfer apparatus of FIG. 4, including tubes which are in close proximity to one another;

FIG. 7 is a cross-sectional view of the apparatus of FIG. 6, taken along the line 7-7;

FIG. 8 is a perspective view of a heat transfer apparatus according to a third embodiment of the invention, adapted for placement on top of a patient's head;

FIG. 9 is a perspective view of a heat transfer apparatus according to a fourth embodiment of the invention, adapted for placement covering a patient's face;

FIG. 10 is a perspective view of a heat transfer apparatus according to a fifth embodiment of the invention, adapted for placement covering a patient's feet; and

FIG. 11 is a perspective view of a heat transfer apparatus according to a sixth embodiment of the invention, adapted for placement surrounding a patient's knee.

### DETAILED DESCRIPTION OF THE INVENTION

### First Embodiment

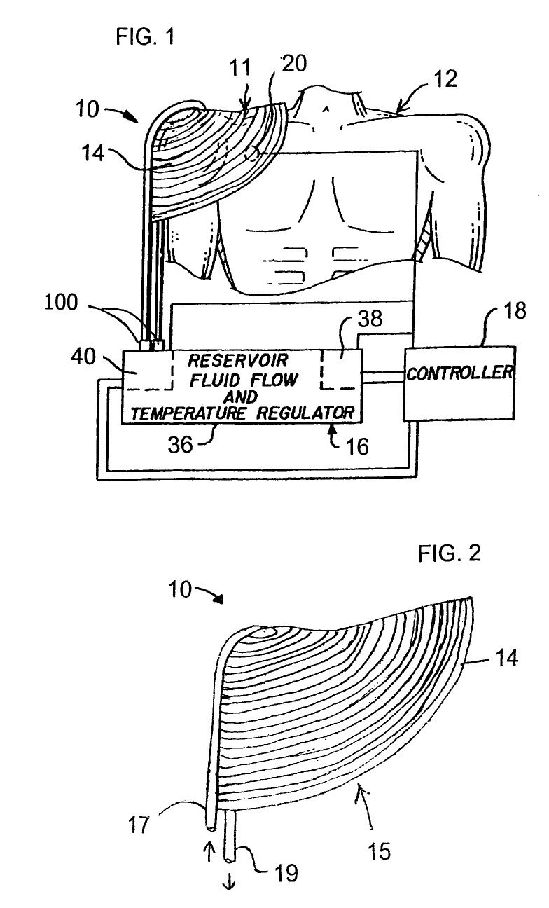

Referring to FIGS. 1-3, a heat transfer apparatus according to a first illustrative embodiment of the present invention is shown generally at 10. The heat transfer apparatus 10 according to the first embodiment is specifically shaped for contacting a shoulder 11 of patient 12. The apparatus 10 includes a main heat transfer member 15, with an inlet tube 17 and an exit tube 19 respectively connected to the main heat transfer member, and in fluid communication therewith. As shown in FIG. 1, the apparatus 10 may be connected to a pressurized source of a flowable heat transfer medium, generally including a mechanism 16 which regulates the flow and temperature of a quantity of the heat transfer medium and a controller 18, such that the heat transfer medium may be passed or circulated through the tubing 14 to effect heat transfer with the object being treated. The heat transfer medium may be an appropriate gas, liquid, gel, etc.

The main heat transfer member 15 may be primarily made up of an arrangement of an elongate, continuous length of flexible tubing 14 which is arranged and bonded into a desired shape, e.g., a shape corresponding to an object to be treated with the apparatus. For arranging the tubing 14 into a desired shape, adjacent sections of the tubing may disposed in contact with each other an appropriately shaped mold, and then bonded together to define the desired shape. For example, the adjacent sections of tubing may be coiled around, laid end-to-end on, etc. on the surface of the mold or object, and then bonded together. The individual tubing sections within the main heat transfer member 15 may be arranged in contact with each other with substantially no open spaces therebetween. Alternatively, some spaces may be provided between selected adjacent sections of tubing, or portions thereof, as necessary or desired, e.g., to define breathing openings, openings for protruding members of an object, etc.

The tubing 14 may have a circular cross section and a relatively small diameter (e.g., ≦ 3/8 inch) for achieving a large heat transfer surface area which would contact the object being treated, and for giving strength to the apparatus. Of course, the invention is not limited to such characteristics, or to the depicted construction shown in the drawings. For example, the tubing 14 may be as small as capillary size or larger than 3/8 inch in diameter if so desired. Generally, smaller diameter tubing is stronger than larger diameter tubing, but it also takes longer to arrange smaller diameter tubing into a desired shape in comparison to the larger diameter tubing. Further, if the tubing diameter is too large, it may collapse upon itself in the “green” state, discussed further below. Although the tubing 14 is shown to have a circular cross sectional shape, again the tubing is not limited to this shape but may be formed in any cross sectional shape as desired. Tubing having the circular cross section tends to be easier to arrange into desired shapes in comparison to other cross sectional shapes.

The tubing 14 may be formed either as one continuous tube arranged in the desired shape, or it may comprise a plurality of lengths of tubing bonded together in the desired shape and connected together with appropriate connectors and/or a manifold such that the heat transfer medium may be flowed through all sections of the tubing.

The tubing 14 may be made of a non-toxic, flexible elastomeric polymer capable of low and high temperature applications. Silicone-containing elastomers have appropriate characteristics and may be used in forming the tubing 14 in the practice of the invention. Additionally, in the practice of the present invention the material used in forming the tubing, as well as conditions established for curing the tubing after it is formed, may be selected and controlled such that crosslinking occurs between contacting surfaces of adjacent tubing sections during the curing process so that the adjacent tubing sections are strongly bonded together. Still further, a material having a memory property may be used for forming the tubing.

According to an important aspect of the invention, the tubing 14 is arranged to form the desired shape of the apparatus 10 while still in an uncured or substantially uncured state, and is thereafter cured with surfaces of adjacent tubing sections remaining in contact with one another in the desired shape, such that engaging surfaces of the adjacent tubing sections are bonded together during the curing process. For example, the tubing may be arranged into the desired shape over a mold while in a substantially uncured state, and thereafter cured while still on the mold such that the tubing sections are bonded together in the desired shape.

An “uncured state” or “substantially uncured state” according to the invention may be any state in which the chemical or molecular structure of the material is capable of further reacting or changing to an appreciable extent under normal or moderately elevated temperature conditions, including a tacky or so-called “green” state just after the tubing is molded or extruded from appropriate raw materials. In such substantially uncured state, the surfaces of the tubing sections are tacky and tend to stick together when the adjacent sections are contacted together. This characteristic facilitates the process of arranging the tubing into a desired shape because the tubing sections tend to stay in place once arranged in contact with other tubing sections and/or with the mold.

Forming the shape of the apparatus 10 is not limited to the use of a mold. Alternatively, for example, the tubing may be formed into the desired shape directly on an object to be subsequently treated with the apparatus, the tubing may be arranged into a planar or substantially planar shape on a flat surface, etc.

Again, the final bonded shape of the apparatus is achieved through curing the tubing 14 while adjacent sections of the tubing 14 are in surface-to-surface contact with each other. Curing may be achieved in any appropriate manner, e.g., allowing the “green” tubing material to further react under ambient or room temperature conditions (e.g., approximately 75° F. and atmospheric pressure), under elevated temperature, under elevated pressure conditions, with the aid of a catalyst, RF radiant heating, etc. Elevated temperatures in a range of 100° F.-575° F., preferably 175° F.-475° F. are appropriate for rapid curing tubing made from silicone materials, but curing temperatures near the upper end of the indicated ranges may cause the tubing to become slightly harder or lose some of its flexibility. On the other hand, curing in a higher temperature oven or autoclave may cause some of the bonds between adjacent, contacted tubing surfaces to break or become weaker or less stable, which is undesirable.

According to another aspect of the invention, the curing process may be conducted so as to promote temperature transfer between the several sections of the tubing, thus achieving a substantially uniform curing temperature throughout the apparatus 10. For example, a gas or other heat transfer medium may be flowed through the tubing 14 during the curing process. Further, if the heat transfer medium has a sufficiently large pressure, this can cause the uncured or substantially uncured tubing to expand slightly, creating greater surface contact between adjacent sections of the tubing, ultimately resulting in stronger bonding between the tubing sections once curing is finished. Of course, a step of flowing pressurized gas or other medium through the uncured or substantially uncured tubing for expanding same may occur prior to the curing process.

As an alternative to flowing the pressurized gas or heat transfer medium through the uncured or substantially uncured tubing to create greater surface contact, a force could be applied to the outer surfaces of the tubing, e.g., via a mechanical press, via application of increased pressure, etc. With such alternative it is important not to apply such a large force that will collapse the tubing excessively, again noting that inner surfaces of the tubing are tacky and would tend to stick together.

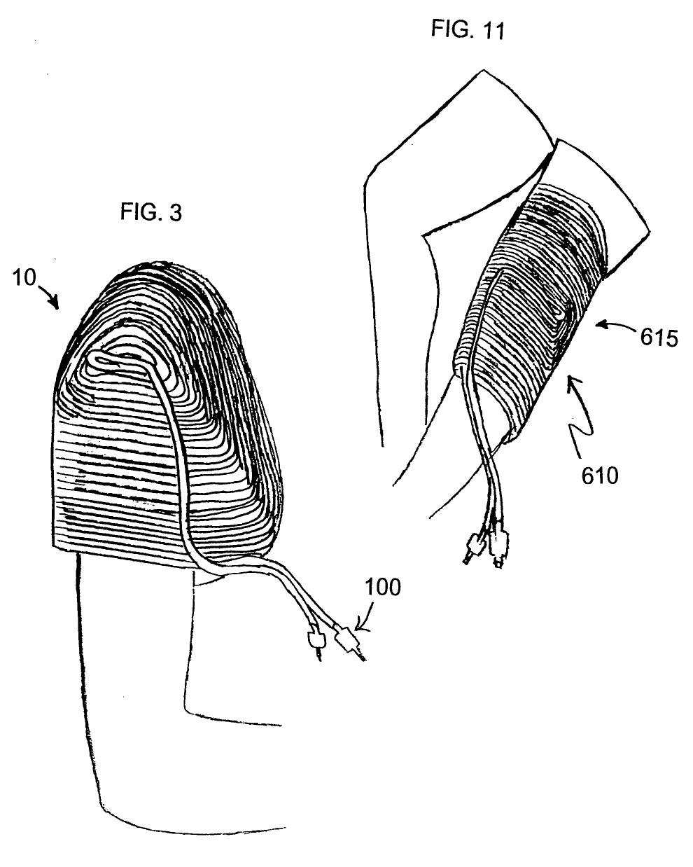

Referring once again to FIG. 1, the mechanism 16 for flowing the heat transfer medium through the tubing 14 may include a reservoir 36 for storing a quantity of the heat transfer medium, a regulator 38 for controlling the temperature, and a flow controller 40 for controlling the flow of the heat transfer medium. The regulator 38 may include a mechanism such as a heating unit and/or a refrigeration unit for heating and/or cooling the heat transfer medium in the reservoir. Alternatively, if the apparatus is to be used for cooling, the regulator 38 may simply comprise a quantity of ice placed in a portion of the reservoir or in a container through which sections(s) of the tubing extend so as cool the heat transfer medium as it passes therethrough. The flow controller 40 may include a pump and a valve for controlling the quantity of heat transfer medium flowing through the tubing 14 per unit time at a desired rate. The apparatus 10 may be connected to the reservoir, fluid flow and temperature regulator 16 through appropriate connectors 100 located at the ends of the tubing 14, as seen in FIGS. 1, 3.

The controller 18 may be an electronic apparatus, digital or analog, used to control the mechanism 16 which regulates the temperature and rate of the heat transfer medium flowing through the tubing 14. The controller 18 may simply comprise an on/off switch which actuates a pump and a heating or cooling unit (if any) of the flow controller 40, but may additionally comprise controls for adjusting the flow rate and temperature of the heat transfer medium.

Further, the controller 18 may operate on a predetermined program, stored in a memory of the controller, which may vary temperature and flow rate of the heat transfer medium in a predetermined manner or cycle over a predetermined period. Where used, the program may be altered at the controller 18.

In addition, information received from a temperature sensor 20 may be used to vary the program of the controller 18, in order to maintain the substrate 16 at a predetermined temperature. The sensor may be appropriately disposed in relation to the object being treated (as depicted in FIG. 1) or elsewhere in relation to the tubing 14 or the heat transfer medium. When the apparatus 10 as disclosed above has been constructed using the coiled/arranged length(s) of tubing 14, during use of the apparatus the flowable heat transfer medium is repeatedly passed from the reservoir 36, through all sections of the tubing, and back to the reservoir. The heat transfer medium may exit the apparatus at a noticeably different (higher or lower) temperature than that at which it entered the apparatus, due to heat transfer to or from the surface of the object being treated. If a single continuous length of tubing 14 is used, the medium correspondingly passes through a single circuitous route. The exiting temperature of the heat transfer medium may be sensed and used as a control parameter/signal by the controller 18.

The temperature sensor 20 may also be used to sense the internal or surface temperature of the object being treated as a control parameter, and may be connected to supply an electrical signal proportional to the temperature of the object directly to the heat transfer medium flow regulator 16 or directly to the temperature regulator 38 instead of to the controller 18 as shown in FIG. 1.

Under certain circumstances, temperature variations in surface of the object being treated may be undesirable (e.g., when heating or cooling an injury to a specific portion of the body, the entire portion of the body that may be injured should be maintained at substantially the same temperature). In such a situation, the apparatus 10 could be made of a number of lengths of the tubing 14 connected together with appropriate connectors and/or a manifold such that the length of time that fluid passing through the apparatus in contact with the object is minimized, and correspondingly the temperature difference of the medium in different sections of the apparatus 10 is minimized.

### Second Embodiment

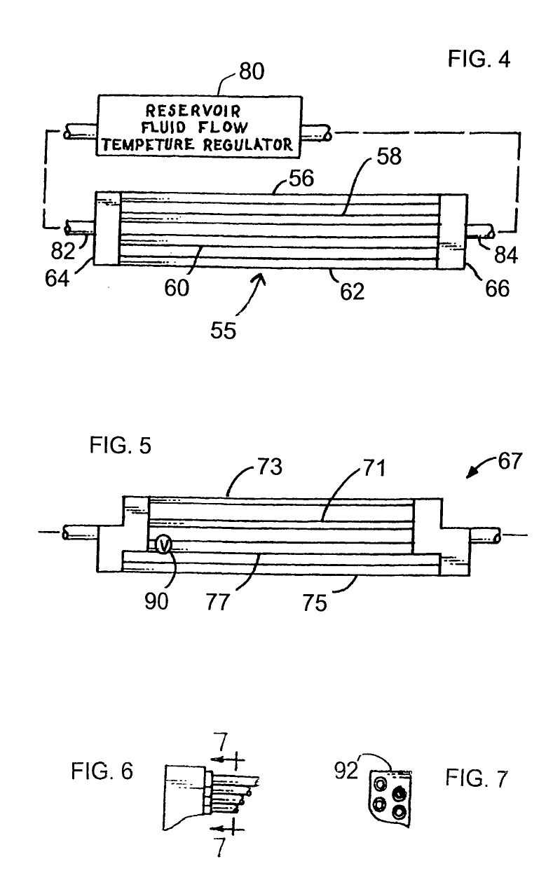

FIG. 4 illustrates an alternative structure according to the present invention. While the main heat transfer member 55 is shown as a rectangular block in FIG. 4 for purposes of illustration, it will be understood that it could be formed in a shape similar to the shape of the main heat transfer member 15 of the first embodiment, or in any other desired shape, according to the above-described aspects of the present invention.

In the structure shown in FIG. 4, a plurality of short lengths of tubing or tubes 56, 58, 60 and 62 are respectively connected to an inlet manifold 64 at one end, and to an outlet manifold 66 at the other end thereof, in place of a single continuous length of tubing 14 shown in FIGS. 1-3. The inlet manifold 64 may be connected to a mechanism 80 for flowing the heat transfer medium through the tubing at a controlled rate and temperature through a single inlet line 82, while the outlet manifold 66 may be connected through a single return line 84 to the mechanism 80.

When the apparatus 55 is constructed with a plurality of tubes operatively connected to manifolds 64, 66 so they are in fluid communication, the tubes 56-62 may all be of the same length and the central section thereof configured so as to conform to the shape of an object which is to be treated. The temperature gradient of the heat transfer medium flowing through the tubes 56-62 will be substantially less than in the first embodiment, since the individual tubes are shorter than a single continuous length of tubing 14, when the tubes 56-62 or tubing 14 are/is conformed to a given shape. Thus, the treated object may maintain a more uniform temperature over the entire surface area being treated with the design of FIG. 4 than with some other designs.

As shown in the modified manifolded structure 67 of FIG. 5, greater control can be asserted over the temperature gradient of tubes 71, 73, 75 and 77 by, for example, changing the diameter of the different tubes which are in contact with the treated object. In the embodiment of FIG. 5, tubes 71 and 73 have a smaller diameter than tubes 75 and 77. Further, the length of the tubing may be altered as well as the shape of the manifolds, to make the temperature gradient between the ends of the tubing more even, particularly in conjunction with tubing of different diameters.

Alternatively, control valves 90 as shown in FIG. 5 may be placed in the individual tubes to variably restrict heat transfer medium flow therein. Such valves may produce greater control over the temperature gradient in the tubing, and may be controlled by a controller such as controller 18 in FIG. 1.

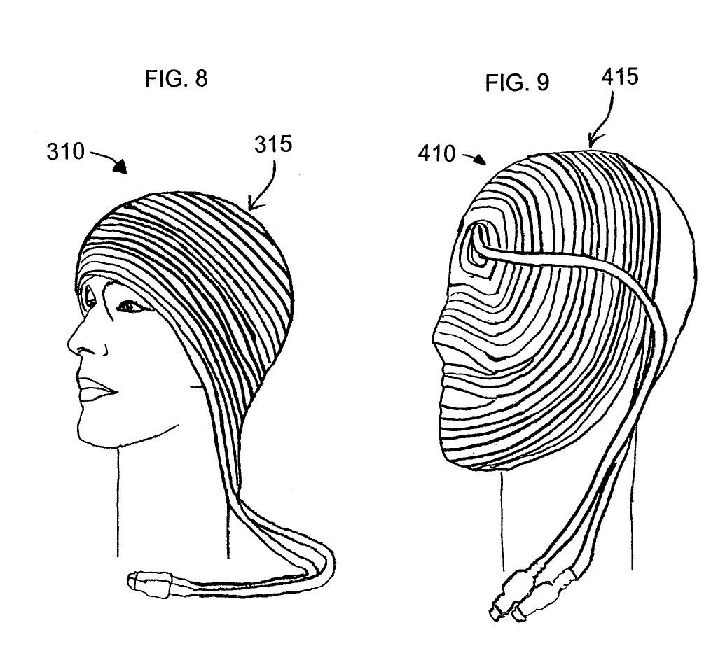

Also as shown in FIGS. 6 and 7, tubing may be secured to the manifolds 82 and 84 so that at least the major sections of the lengths of the tubes can be in surface-to-surface contact with adequate connection via member 92 to the manifolds at their ends.

Alternative Therapeutic Embodiments

In a number of therapeutic medical applications thereof, the apparatus according to the invention may be formed to conform to the shape of a body part which is to be treated.

For example, in FIG. 8, a third embodiment of a heat exchange apparatus 310 according to the invention may be formed with a main heat transfer member 315 formed in the shape of a patient's head (excluding the face).

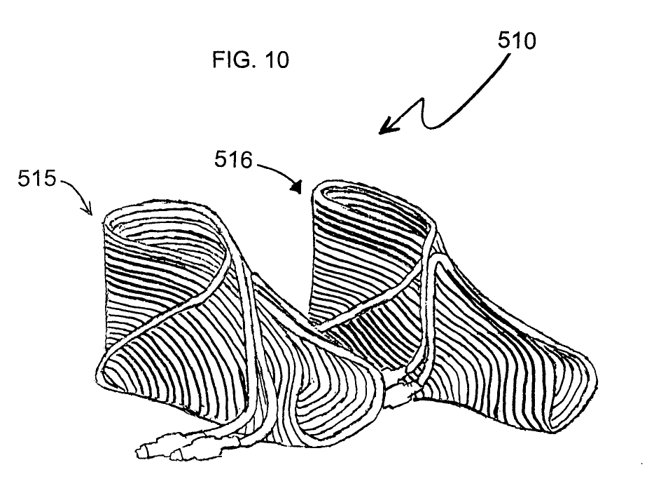

As shown in FIG. 9, a fourth embodiment of a heat exchange apparatus 410 according to the invention may be formed with a main heat transfer member 415 formed in the shape of a patient's face. Again, appropriate spaces may be defined between sections of the tubing corresponding to a mouth and/or nostrils for breathing, corresponding to the eyes, corresponding to the ears, etc. The embodiments of FIGS. 8-9 are particularly useful for cooling a patient's brain, which may be desirable in the event of stroke or traumatic head injury. Similarly, an apparatus could be formed which completely covers a patient's head, except for breathing openings, etc.

As shown in FIG. 10, a fifth embodiment of a heat exchange apparatus 510 according to the invention may be formed with a pair of main heat transfer members 515, 516 formed in the shape of a patient's feet. Of course, only a single of these main heat transfer members 515, 516 may be needed for a specific application, or both may be used simultaneously, where appropriate.

As shown in FIG. 11, a sixth embodiment of a heat exchange apparatus 610 according to the invention may be formed with a main heat transfer member 515 formed in the shape of a sleeve which surrounds a patient's knee (which may be interchangeable with the other knee).

However, the shape and application of the apparatus according to the invention is not limited to the shapes and applications shown in these figures. For therapeutic applications, the apparatus may be made in the shape of substantially any body part, or may be formed as a planar or substantially planar member which may be draped over or wrapped around a given body part or other object. Further, for other applications, the apparatus hereof may be formed in the shape of any desired workpiece, which may be for an industrial application rather that a medical application.

Still further, a fastening mechanism (not shown) may be provided with the heat transfer apparatus according to any of the embodiments of the invention to help secure the apparatus in proper engagement with an object being treated, for optimum heat transfer efficiency. For example, appropriate fastening mechanisms include straps, snaps, elastic bands, hook-and-loop (Velcro®) fastening members, etc. Similarly, while not shown in the drawings, an additional insulative cover could be provided over the outer surface of the heat transfer apparatus to prevent undesired heat transfer between the apparatus and the ambient environment through convection, etc.

Although the present invention has been described herein with respect to a preferred embodiment thereof, the foregoing description may be intended to be illustrative, and not restrictive. Those skilled in the art will realize that many modifications and variations may be made to the present embodiments within the spirit and scope of the invention, the scope of which is indicated by the appended claims.

1. A method for manufacturing a heat transfer device, comprising the steps of:
forming tubing of a curable material;
thereafter while the tubing is in a substantially uncured state, arranging said tubing into a desired shape such that surfaces of adjacent sections of the tubing in contact with each other; and
curing the shaped tubing while in said desired shape such that contacting surfaces said adjacent sections of said tubing are bonded together.

2. The method of claim 1, wherein said arranging step involves arranging sections of said tubing on a surface of a mold such that surfaces of adjacent sections of the tubing are in contact with each other.

3. The method of claim 1, wherein said curable material comprises an elastomeric material which is flexible after curing.

4. The method of claim 3, wherein said elastomeric material comprises a crosslinking silicone material.

5. The method of claim 1, wherein said curable material is crosslinkable and said curing step causes the contacting surfaces of adjacent segments of the tubing to be crosslinked to each other.

6. The method of claim 1, further including the step of forcing the surfaces of the adjacent sections of the tubing as arranged into the desired shape into greater contact with each other prior to or during said curing step.

7. The method of claim 6, wherein said forcing step involves flowing a pressurized medium through said tubing.

8. The method of claim 1, wherein said curing step is performed at ambient conditions.

9. The method of claim 1, wherein said curing step is performed at a temperature of 100° F.-575° F.

10. The method of claim 1, wherein a diameter of said tubing is ≦ 3/8 inch.

11. The method of claim 2, wherein a shape of said mold corresponds to a given body part.

12. The method of claim 1, further comprising the step of applying pressure to said tubing to increase an amount of surface area contact between adjacent segments of said tubing as arranged in said desired shape, prior to or during said curing step.

13. The method of claim 12, wherein said pressure comprises at least one of a pneumatic pressure and a mechanical pressure.

14. The method of claim 12, wherein said pressure is applied to at least one of an internal surface and an external surface of said tube.

15. The method of claim 1, wherein said tubing comprises a single continuous length of tubing.

16. A heat transfer device formed according to the method of claim 1.

17. The device of claim 16, wherein said curable material comprises an elastomeric material which is flexible after curing.

18. The device of claim 16, wherein said curable material is at least one of a silicone material and a crosslinking material.

19. The device of claim 16, wherein the contacting surfaces of said adjacent segments of said tubing are crosslinked to each.

20. The device as set forth in claim 1, wherein a diameter of said tubing is ≦ 3/8 inch.
